(19) United States
(12) Patent Application Publication
(10) Pub. No.: US 2026/0339958 A1
(43) Pub. Date: Oct. 29, 2026

(54) DATABASE BINARY BLOCK PARTITIONING

(71) Applicant: International Business Machines Corporation, Armonk, NY (US)

(72) Inventors: Pedro Miguel Barbas, Dunboyne (IE); Rajat Agrawal, Gorey (IE); STEFA ETCHEGARAY GARCIA, Sleepy Hollow, NY (US)

(21) Appl. No.: 19/231,725

(22) Filed: Jun. 9, 2025

(30) Foreign Application Priority Data
Apr. 28, 2025 (GB) 2506341.3

(51) Int. Cl. G06F 16/2455; G06F 16/242; G06F 16/2453

(52) U.S. Cl. CPC G06F 16/24554; G06F 16/244; G06F 16/24537

(57) ABSTRACT

Binary block partitioning is performed for compression of a database having a plurality of records with multiple attributes. The partitioning includes dynamically providing partitions of the database by encoding attributes of the records into binary representations and assigns each attribute value to a partition based on its binary form to provide a probabilistic filter for each attribute and assigns mappings to identify a partition for an attribute value wherein the mappings are derived from the probabilistic filters. The partitioning further includes analyzing query criteria to the database to identify partitions relevant to a query using the probabilistic filters and to prioritize partitions for data retrieval for the query based on query patterns and historical access data.

### BACKGROUND

The present invention relates to binary block partitioning, and more specifically, to binary block partitioning using machine learning for dynamic partitioning.

In the realm of high-performance data warehousing, efficient data compression has become indispensable. Many modern database management systems (DBMSs) now offer robust support for storing data in compressed formats, aiming to minimize storage requirements and optimize input/output operations. To further streamline processing, these systems often leverage dictionary or prefix encoding techniques, enabling direct operations on compressed values such as predicate evaluation and joins.

### SUMMARY

According to an aspect of the present invention there is provided a computer-implemented method for binary block partitioning for compression of a database having a plurality of records with multiple attributes, the method includes: dynamically providing partitions of the database by encoding attributes of the records into binary representations and assigning each attribute value to a partition based on its binary form to provide a probabilistic filter for each attribute; assigning mappings to identify a partition for an attribute value wherein the mappings are derived from the probabilistic filters; and analyzing query criteria to the database to identify partitions relevant to a query using the probabilistic filters and to prioritize partitions for data retrieval for the query based on query patterns and historical access data.

According to another aspect of the present invention there is provided a system for binary block partitioning for compression of a database having a plurality of records with multiple attributes, the system includes: a memory containing one or more instructions; and a processor communicatively coupled to the memory, the processor, in response to reading the one or more instructions, configured to: dynamically provide partitions of the database by encoding attributes of the records into binary representations and assigning each attribute value to a partition based on its binary form to provide a probabilistic filter for each attribute; assign mappings to identify a partition for an attribute value wherein the mappings are derived from the probabilistic filters; and analyze query criteria to the database to identify partitions relevant to a query using the probabilistic filters and to prioritize partitions for data retrieval for the query based on query patterns and historical access data.

According to a further aspect of the present invention there is provided a computer program product for binary block partitioning for compression of a database having a plurality of records with multiple attributes, the computer program product includes a computer readable storage medium having program instructions embodied therewith, the program instructions executable by a processor to cause the processor to: dynamically provide partitions of the database by encoding attributes of the records into binary representations and assigning each attribute value to a partition based on its binary form to provide a probabilistic filter for each attribute; assign mappings to identify a partition for an attribute value wherein the mappings are derived from the probabilistic filters; and analyze query criteria to the database to identify partitions relevant to a query using the probabilistic filters and to prioritize partitions for data retrieval for the query based on query patterns and historical access data.

The computer readable storage medium may be a non-transitory computer readable storage medium and the computer readable program code may be executable by a processing circuit.

The present invention seeks to provide one or more concepts for database binary block partitioning. Such concepts may be computer implemented. That is, such methods may be implemented in a computer infrastructure having computer executable code tangibly embodied on a computer readable storage medium having programming instructions configured to perform a proposed method. The present invention further seeks to provide a computer program product including computer program code for implementing the proposed concepts when executed on a processor.

### BRIEF DESCRIPTION OF THE DRAWINGS

Embodiments of the present invention will now be described, by way of example only, with reference to the accompanying drawings:

FIG. 1 is a flow diagram of an example embodiment of a method in accordance with embodiments of the present invention;

FIG. 2 is a flow diagram of another example embodiment of a method in accordance with embodiments of the present invention;

FIG. 3 is a flow diagram of a further example embodiment of a method in accordance with embodiments of the present invention;

FIG. 4 is a block diagram of an example embodiment of a system in accordance with embodiments of the present invention; and

FIG. 5 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Despite the advantages of compressed databases, several challenges persist, particularly in handling new data values and wide-sparse tables. While processing fixed-length and fixed-format data is straightforward and fast, accommodating new values in compressed databases may necessitate support for diverse representations, including both encoded and unencoded formats. Moreover, wide-sparse tables, characterized by numerous attributes with only a subset containing non-null values per record, pose unique challenges. Representing null values within the DBMS's encoding framework can impact query performance, highlighting the need for careful management of encoding configurations.

Transitioning from traditional storage formats to compressed ones requires significant restructuring of the underlying data structure, posing challenges in terms of time, resources, and optimization of query performance. Additionally, concurrency control and transaction management become areas of concern, requiring adaptation to ensure consistency and isolation levels within the compressed storage structure.

Furthermore, efficient indexing strategies tailored to compressed storage formats may accelerate query processing, necessitating the development of sophisticated indexing structures and techniques.

Optimizing query execution plans and estimating query costs in the context of compressed storage adds another layer of complexity, requiring the adaptation or extension of traditional query optimization techniques. This includes the development of sophisticated cost estimation models and query optimizers tailored to compressed storage environments. Addressing these challenges demands a comprehensive understanding of database internals and the specific requirements of the application environment, often involving research, experimentation, and iterative refinement to achieve optimal performance and scalability in compressed database storage systems.

Embodiments of a method, system, and computer program product are provided for binary block partitioning that combines the principles of binary block partitioning such as organizing and grouping data into blocks based on common patterns or sequences within their binary representations, with artificial intelligence (AI) driven techniques. The AI techniques aim to optimize data organization, storage efficiency, query processing, and/or adaptability to changing data patterns.

The described binary block partitioning provides adaptive AI-driven partitioning. The method utilizes machine learning algorithms to dynamically adjust partitioning strategies based on real-time data analysis and query workload. This results in more adaptive and efficient partitioning than conventional static partitioning based on data representation. The described method adapts well to changing data distributions or query patterns.

The described binary block partitioning may provide AI-optimized encoding. The method leverages AI algorithms to continuously optimize encoding schemes based on data characteristics, leading to better compression ratios and faster query processing than conventional fixed encoding schemes. The described method may optimize storage efficiency and query performance across diverse datasets.

The described method may automate binary block partition management using AI-driven algorithms that adaptively partition data based on evolving data patterns and query demands. This reduces the need for manual intervention and improves overall system scalability. This also scales well with large datasets or complex query patterns.

The described binary block partitioning may provide AI-driven flexibility. The described method offers flexibility and adaptability by continuously learning from data trends and query behaviors, enabling it to adjust partitioning strategies on-the-fly to optimize performance in various scenarios.

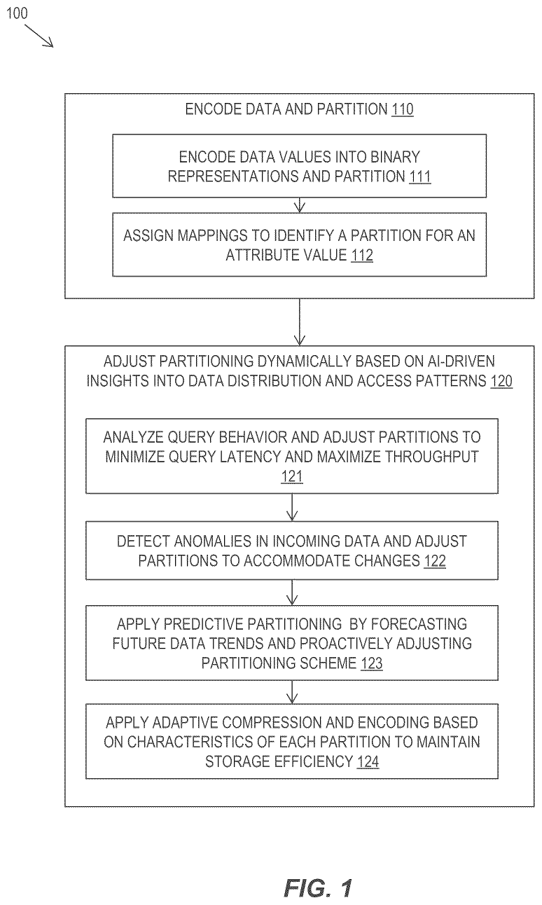

Referring to FIG. 1, a flow diagram 100 shows an example embodiment of the described method of binary block partitioning for compression of a database having a plurality of records, with each record having multiple attributes. A record instance has attribute values stored in the database.

The method may encode and partition 110 data in the database. This dynamically provides partitions of the database by encoding 111 attributes of the records into binary representations and assigning each attribute value to a partition based on its binary form to provide a probabilistic filter for each attribute. This encoding process converts data attributes such as strings, integers, or floating-point numbers into sequences of binary digits (bits). Each attribute is represented using a fixed number of bits, which may vary depending on the data type and precision requirements. In binary block partitioning, the partitioning strategy revolves around grouping data into blocks based on common patterns or sequences within their binary representations. This involves partitioning data based on specific bit positions, such as grouping all records where certain bits are set or unset. The encoding includes assigning 112 mappings to identify a partition for an attribute value with the mappings derived from the probabilistic filters. This may be by assigning tuple map values, such as hash values.

It should be noted that the described method relates to organizing data across blocks and not to intra-block partitioning where the focus is on organizing data within individual blocks.

The described method dynamically adjusts 120 the partitioning based on data distribution and access patterns of the database. AI algorithms may analyze historical data patterns, anomalies, and correlations to identify optimal partitioning schemes based on the binary representations. The partitioning strategy is not predefined but dynamically adjusted based on AI-driven insights into the data distribution and access patterns.

The method analyzes 121 query behavior and adjust partitions. AI algorithms may analyze query patterns, user behaviors, and historical query performance to optimize query processing. Query optimization techniques prioritize relevant partitions for retrieval based on the query criteria, leveraging AI insights into data access patterns. By adapting partitioning schemes to query patterns, AI-driven binary block partitioning minimizes query latency and maximizes throughput.

The method may detect 122 anomalies in incoming data and adjust partitions to accommodate changes. AI-driven anomaly detection algorithms continuously monitor incoming data to identify unusual records or changes in data patterns. When anomalies are detected, the partitioning scheme may be dynamically adjusted to accommodate the changes and optimize data organization. This dynamic adaptation ensures that the partitioning remains efficient and effective in capturing the evolving characteristics of the data.

The method may apply predictive partitioning 123. AI models may forecast future data trends and access patterns based on historical data and external factors. Predictive partitioning anticipates future data distribution changes and proactively adjusts partitioning schemes to accommodate upcoming shifts. This proactive approach ensures that the data organization remains optimized even as the data landscape evolves over time.

The method may apply 124 adaptive compression and encoding. AI-driven algorithms optimize data compression and encoding techniques based on the characteristics of each partition. Compression algorithms adapt to changing data distributions, ensuring that storage efficiency is maintained over time. Encoding strategies are dynamically adjusted to maximize query performance and minimize storage overhead based on AI insights into data access patterns.

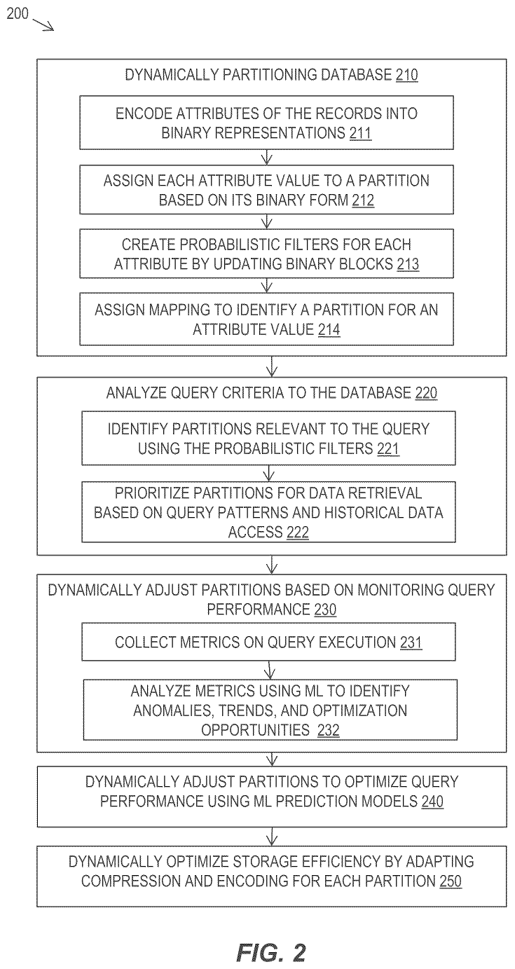

Referring to FIG. 2, a flow diagram 200 shows an example embodiment of the described computer-implemented method for binary block partitioning for compression of a database having a plurality of records with multiple attributes.

The method dynamically 210 partitions the database. This includes encoding 211 attributes of the records into binary representations, assigning 212 each attribute value to a partition based on its binary form, where partitions are grouped by common patterns or sequences in the binary representations, and creating 213 a probabilistic filter for each attribute by updating binary blocks based on the encoded attribute values, with each block corresponds to a distinct range or category of attribute values.

This may include partitioning data using bitwise operations and grouping records with specific bit positions to enable optimization where certain bits are set or unset. Dynamically 210 providing and updating partitions includes updating for new or changed records to maintain balance between partitions and providing updated probabilistic filters.

The method assigns 214 mappings, such as tuple map values, are assigned 214 to identify the partition for each attribute value, with the mappings derived from the probabilistic filters. This provides grouping of data into blocks based on common patterns within binary sequences, allowing efficient storage and retrieval.

The method analyzes 220 query criteria of incoming queries to the database to identify 221 partitions relevant to a query using the probabilistic filters and prioritizing 222 partitions for data retrieval for the query based on query patterns and historical access data. This may analyze query patterns with user behavior and performance history to optimize query processing with the partitions are prioritized based on query criteria, using AI insights for efficient access patterns. Prioritizing partitions may be based on hash values generated from query conditions and their corresponding position in the probabilistic filters. The prioritizing partitions may apply a bitwise AND operation for refining selection by filtering out partitions that do not meet query criteria. The analysis 220 of query criteria may be carried out by a machine learning system.

The method may dynamically adjust 230 partitions based on monitoring query performance and, optionally database usage, by collecting 231 and analyzing 232 query metrics to identify optimization opportunities, such as anomalies and trends. The method may analyze monitored data using machine learning to adjust the partitions to optimize query performance based on the monitoring and analysis. This adapts partitions in response to query trends, reducing latency, and maximizing throughput. The method may monitor historical data patterns and anomalies in the database to refine partitioning based on binary characteristics and adjusting the partitions dynamically in response to data patterns and anomaly detection.

The method may proactively adjust 240 the partitions by reallocating attribute values based on machine learning predictions of future data distribution and query workloads and real-time analysis to optimize query performance. The method may forecast future data distribution and access patterns based on historical data and external factors and may proactively adjust the partitions.

The method may dynamically adjust 250 the partitions to optimize storage efficiency by adapting compression and encoding for each partition based on characteristics of each partition based on machine learning analysis. The method may provide adaptive compression and encoding based on characteristics of each partition. Compression algorithms may adapt to changing data distributions, ensuring that storage efficiency is maintained over time. This may dynamically adjust encoding strategies to maximize query performance and minimize storage overhead based on machine learning insights into data access patterns.

Reinforcement learning may be applied to the machine learning aspects to improve strategies over time based on feedback from monitoring and analysis. The described method may continuously optimize encoding schemes using machine learning based on data characteristics to provide better compression ratios and faster query processing. The machine learning may be applied to carry out one or more of: optimize indexing, cache frequently accessed data, and dynamically allocating resources based on workload patterns.

The described method and system use one or more AI models that apply machine learning for aspects of anomaly detection, query optimization, predictive partitioning, and compression optimization. The AI models are trained on historical data using supervised or unsupervised learning techniques. Reinforcement learning models are trained through interaction with a simulated database environment.

Evaluation metrics may include the following. For anomaly detection precision, recall an F1-score may be used for evaluation. For query optimization, query execution time, and throughput may be used for evaluation. For predictive partitioning, mean absolute error (MAE) for forecasts may be used for evaluation. For compression optimization, compression ratio, and query performance may be used for evaluation.

Trained models may be integrated into a database management system. Real-time monitoring and feedback loops ensure continuous improvement. Further example implementation detail of the AI models for each aspect are provided below.

### Anomaly Detection for Dynamic Partition Adjustment

The goal may be to identify unusual data patterns or query behaviors that may necessitate partition adjustments.

The training dataset for this modeling may use a data source of historical database logs containing data distribution patterns, query execution times, and partition usage statistics. Features used may be: (i) data distribution metrics (e.g., skewness, variance), (ii) query patterns (e.g., frequency of specific queries, access patterns), and/or (iii) partition performance metrics (e.g., retrieval times, storage utilization). Labels may be anomalies identified by domain experts or automated tools (e.g., sudden spikes in query latency, unusual data distribution shifts).

The model type used may be an autoencoder (unsupervised learning) or Isolation Forest (anomaly detection). For an autoencoder, the topology may be a neural network with an encoder-decoder architecture. The encoder compresses input data into a latent representation, and the decoder reconstructs the data. Anomalies are detected based on reconstruction error. Training objectives may be to minimize reconstruction error. A loss function may be Mean Squared Error (MSE) between input and reconstructed data.

For Isolation Forest, the topology may be an ensemble of decision trees that isolate anomalies by randomly selecting features and splitting values. Anomalies are identified as data points requiring fewer splits to isolate. A loss function may be anomaly score based on path length in decision trees.

### Query Pattern Analysis for Partition Prioritization

The goal may be to optimize query performance by prioritizing partitions that are most likely to contain relevant data. Training objectives may be to predict the most relevant partitions for a given query based on historical patterns.

The training dataset for this modeling may use a data source of query logs containing historical query patterns, execution times, and accessed partitions. Features may be: (i) query type (e.g., SELECT, JOIN, FILTER), (ii) accessed partitions and their metadata, (iii) query execution time, and (iv) resource usage. Labels may be optimal partitions for specific query types (determined by historical performance data).

The model types used may be Gradient Boosting Machines (GBM) or Recurrent Neural Networks (RNN). For GBM, the topology may be an ensemble of decision trees trained sequentially to minimize residual errors. Loss function for GBM may be log loss or mean squared error. For RNN the topology may be a neural network with recurrent layers to capture temporal dependencies in query patterns. Loss function for RNN may be categorical cross-entropy for classification tasks.

### Predictive Partitioning for Future Data Trends

The modeling goal may be to proactively adjust partitioning schemes to accommodate anticipated changes in data distribution or query workloads. The training objective may be to forecast future data distribution and query workload trends.

The training dataset may use a data source of time-series data of data distribution trends, query workloads, and external factors (e.g., seasonal trends, business growth). Features may be: historical data distribution metrics, query workload trends, external factors (e.g., time of year, business events). Labels may be future data distribution patterns or query workloads (derived from historical trends).

The model may be Long Short-Term Memory (LSTM) networks or Prophet (Facebook's time-series forecasting model). For LSTM, the topology may be a type of RNN with memory cells to capture long-term dependencies in time-series data. The loss function for LSTM may be Mean Squared Error (MSE) or Mean Absolute Error (MAE). For Prophet, the topology may be decomposable time-series model that handles seasonality, trends, and holidays. The loss function for Prophet may be custom loss function combining trend, seasonality, and holiday components.

### Adaptive Compression and Encoding Optimization

The modeling goal may be to dynamically adapt encoding schemes to maximize storage efficiency and query performance. The training objective is to maximize reward (e.g., compression efficiency, query performance) by selecting optimal encoding schemes.

The training dataset may use a data source of a dataset containing various data types (e.g., strings, integers, floating-point numbers) and their compression metrics. Features may include: (i) data type and characteristics (e.g., entropy, uniqueness), (ii) compression ratios, and (iii) query performance metrics for different encoding schemes. Labels may be optimal encoding scheme for each data type (determined by compression efficiency and query performance).

The model may be a Reinforcement Learning (RL) with a policy gradient method. The topology of the RL Agent may be a neural network that learns a policy for selecting encoding schemes based on rewards (e.g., improved compression ratio, faster query performance). The environment may be a simulated database environment where the agent interacts with different encoding schemes and observes outcomes. Loss function may be a policy gradient loss, which maximizes the expected reward.

### Reinforcement Learning for Continuous Optimization

The goal may be to continuously improve system performance by adapting to changing workloads and data patterns. The training objective may be to learn a policy for dynamically adjusting partitioning and resource allocation to optimize system performance.

The training dataset may use a data source of a continuous stream of query performance metrics, partition usage statistics, and system resource utilization. Features may include: (i) query execution times, (ii) partition access patterns, and (iii) system resource usage (e.g., CPU, memory, disk I/O). Labels may be actions (e.g., adjust partition boundaries, reallocate resources) and their associated rewards (e.g., improved query performance, reduced resource usage).

The model may be a Deep Q-Network (DQN) or Proximal Policy Optimization (PPO). For a DQN, the topology may be neural network that approximates the Q-value function for selecting actions. The loss function may be mean squared error between predicted and target Q-values. For a PPO, the topology may be a policy optimization algorithm that balances exploration and exploitation. The loss function may be clipped surrogate objective function to ensure stable policy updates.

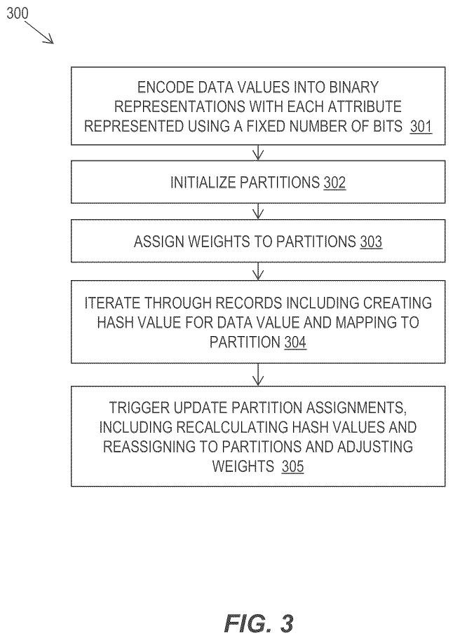

Referring to FIG. 3, a flow diagram 300 shows an aspect of the described method of an implementation of a binary block compression for a database.

The method may encode 301 data values into binary representations with each attribute represented using a fixed number of bits. Partitions may be initialized 302 for an attribute. A set of initial partitions may be represented for ranges of attribute values of an attribute. For example, the method may initialize seven partitions representing distinct score ranges in a competition, such as 40,000-50,000, 50,000-60,000, and so on.

Each partition is assigned 303 a weight. An initial weight may be assigned to a partition, and this may be adjusted based on analysis of the distribution of attribute values across partitions. The method analyzes a distribution of attributes across the partitions and assigning weights to partitions based on the distribution. In the competition example, this may analyze the distribution of high scores across partitions and assign weights accordingly. For example, if an example partition represents the highest score range and has a larger number of participants compared to other partitions, it might receive a higher weight.

The method may iterate 304 through the records to calculate hash values for the record attributes and assigning the hash values to a partition based on the probabilistic filter. In the competition example, the method may iterate through each participant in the dataset and calculate the hash value of their high score. Map the hash value to the corresponding partition based on the probabilistic filter created and update a count of participants in each partition as participants are assigned.

The method may trigger 305 updating of partitions and weights based on changes in the database and recalculates hash values to reassign them to the updated partitions. Periodically or when significant changes occur in the dataset, an update of partition assignments may be triggered. In the competition example, this may recalculate the hash values of the high scores of each participant and reassign them to partitions based on the updated probabilistic filter and may adjust weights of partitions, if necessary, based on changes in the score distribution.

The method is described further using an example participant dataset in Table 1.

TABLE 1
Example Participant Dataset.

| Participant | Experience Level | High Score |
|---|---|---|
| Alice | 25 | 60,000 |
| Bob | 35 | 40,000 |
| Charlie | 28 | 70,000 |
| Mary | 29 | 45,000 |
| Bobby | 37 | 50,000 |
| Peter | 26 | 90,000 |

### Encoding Data Values:

Step 1: Initialize a first filter for columns Participant and High Score. Create a binary 7-buckets/blocks probabilistic filter with each block having a size of 6 bits initialized with 0. Each bucket represents one of the distinct score ranges.
Step 2: Update the filter based on High Score as follows:
1. Assign weights to blocks: Assign weights to each block based on the score range. For example, block 1 for score range 40,000-50,000 has a weight of 1, block 2 for score range 50,000-60,000 has a weight of 2, and so on up to block 7 for score range 90,000-100,000 with a weight of 7.
2. Update filter for each high score:

For each high score, determine the corresponding block. Update the filter by setting the bit at the hashed position for that high score. The hashed position is determined by the score range (bucket) and a default bit position within the block.

An example calculation follows given Dataset 1 shown in Table 2.

TABLE 2
Dataset 1 for Example Calculations.

| Participant | High Score |
|---|---|
| Alice | 60,000 |
| Bob | 40,000 |
| Charlie | 70,000 |
| Mary | 45,000 |
| Bobby | 50,000 |
| Peter | 90,000 |

Using a 7-buckets/blocks probabilistic filter with 6-bit size blocks initialized with 0:000000 000000 000000 000000 000000 000000 000000

Updating the filter based on the high scores:
Adding high score 60,000 to block 3: 000000 000000 100000 000000 000000 000000 000000
Adding high score 40,000 to block 1: 110000 000000 000000 000000 000000 000000 000000
Adding high score 70,000 to block 4: 110000 001000 000000 000000 000000 000000 000000
Adding high score 45,000 to block 1: 111000 001000 000000 000000 000000 000000 000000
Adding high score 50,000 to block 1: 111100 001000 000000 000000 000000 000000 000000
Adding high score 90,000 to block 7: 111100 001000 000000 000000 000000 000000 001000

Adding 40,000 to Block 1, High Score: 40,000, Block Assignment: Block 1 (40,000-50,000). The Bit Position is calculated as follows:
The hash function calculates the bit position within Block 1. For example:
Hash function: bit_position=(score % 6)+1
For 40,000:40,000% 6=4→Bit position 5 (since we count from 1).
Alternatively, if the hash function is simpler (e.g., score//10,000% 6):
40,000//10,000=4→4% 6=4→Bit position 5.

Update:
Set the 5th bit in Block 1 to 1.
Initial filter: 000000 000000 000000 000000 000000 000000 000000
After updating Block 1:000010 000000 000000 000000 000000 000000 000000

However, in the example provided:
Adding high score 40,000 to block 1:110000 000000 000000 000000 000000 000000 000000

This suggests that:
The 1 is placed in the 1st and 2nd bits of Block 1.
This could happen if the hash function maps $40,000 to multiple bit positions (e.g., using a Bloom filter-like approach).

Adding 70,000 to Block 3, High Score: 70,000, Block Assignment: Block 4 (70,000-80,000). The Bit Position is calculated as follows:
Using the hash function: bit_position=(score % 6)+1
For 70,000:70,000% 6=4→Bit position 5.
Alternatively, if the hash function is score//10,000% 6:
70,000//10,000=7→7% 6=1→Bit position 2.

Update:
Set the 5th bit in Block 4 to 1.
Filter after adding 40,000: 110000 000000 000000 000000 000000 000000 000000
After updating Block 4: 110000 000000 000000 000010 000000 000000 000000

This process creates a first binary encoding that represents the distinct score ranges in the dataset using a probabilistic filter.
Step 3: Initialize the second filter for columns Participant and Experience Level.

Create a binary 7-buckets/blocks probabilistic filter with each block having a size of 6 bits initialized with 0. Each bucket represents one of the distinct experience levels.
Step 4: Update the filter based on experience level.
1. Assign weights to blocks: assign weights to each block based on the experience level. For example, block 1 for level 25 has a weight of 1, block 2 for level 26 has a weight of 2, and so on up to block 7 for level 37 with a weight of 7.
2. Update filter for each experience level: for each level, determine the corresponding block. Update the filter by setting the bit at the hashed position for that level. The hashed position is determined by the experience level (bucket) and a default bit position within the block.

An example calculation follows given Dataset 2 in Table 3.

TABLE 3
Dataset 1 for Example Calculations.

| Participant | Experience Level |
|---|---|
| Alice | 25 |
| Bob | 35 |
| Charlie | 28 |
| Mary | 29 |
| Bobby | 37 |
| Peter | 26 |

Using a 7-buckets/blocks probabilistic filter with 6-bit size blocks initialized with 0:000000 000000 000000 000000 000000 000000 000000

Updating the filter based on the levels:
Adding level 25 to block 1: 100000 000000 000000 000000 000000 000000 000000
Adding level 35 to block 7: 100000 000000 000000 000000 000000 000000 100000
Adding level 28 to block 3: 100000 000100 000000 000000 000000 000000 100000
Adding level 29 to block 4: 100000 000100 001000 000000 000000 000000 100000
Adding level 37 to block 7: 100000 000100 001000 000000 000000 000000 100001
Adding level 26 to block 2: 100000 000110 001000 000000 000000 000000 100001

This process creates a second binary encoding that represents the distinct levels in the dataset using a probabilistic filter.

Consequently, the final filters for processing are given by:
111100 001000 000000 000000 000000 000000 001000
100000 000110 001000 000000 000000 000000 100001

### Partition Assignment

1. Initialization of Partitions: Partitions are initialized based on the blocks created in the encoding data values step. Each block corresponds to a distinct score range. Given the exemplary dataset, there are seven partitions representing different score ranges.

```
# Initialize partitions based on score ranges partitions = {
  “40,000 - 50,000”: [ ] ,
  “50,000 - 60,000”: [ ] ,
  “60,000 - 70,000”: [ ] ,
  “70,000 - 80,000”: [ ] ,
  “80,000 - 90,000”: [ ] ,
  “90,000 - 100,000”: [ ] ,
  “100,000 and above”: [ ]
}
# Assign initial weights to each partition weights = {
  “40,000 - 50,000”: 1,
  “50,000 - 60,000”: 2,
  “60,000 - 70,000”: 3,
  “70,000 - 80,000”: 4,
  “80,000 - 90,000”: 5,
  “90,000 - 100,000”: 6,
  “100,000 and above”: 7
}
```

2. Assign Weights to Partitions: Assign weights to each partition based on the score range represented by the block. This weighting ensures that partitions with more significant ranges or more data points are given higher priority during query processing. For example, partitions representing higher score ranges or those with more participants might receive higher weights. Assigning weights may be based on various factors like the number of participants, the spread of scores within the partition, or the significance of the score range to the competition.

```
# Analyze the distribution of high scores across partitions and assign weights accordingly for
partition_name, participants in partitions.items( ):
  weight = len(participants) * weights[partition_name] # Adjust weight based on the
number of participants
  weights[partition_ participant] = weight
```

3. Assign Participants to Partitions: Each participant is assigned to a partition based on the weighted blocks indicated by the probabilistic filter created in the encoding data values step. This assignment ensures that each participant is placed in the partition most relevant to their score range. The hash value is calculated of the high score of each participant, and it is mapped to the appropriate partition based on the probabilistic filter. For example, if a score hash falls within the range represented by Partition 3 in the probabilistic filter, that participant is assigned to Partition 3.

```
def map_to_partition(score_hash):
  # Define hash ranges corresponding to each partition
  hash_ranges = [
    (0, 4), # 40,000 - 50,000
    (5, 11), # 50,000 - 60,000
    (12, 17), # 60,000 - 70,000
    (18, 22), # 70,000 - 80,000
    (23, 26), # 80,000 - 90,000
    (27, 29), # 90,000 - 100,000
    (30, 31) # 100,000 and above
  ]
  # Iterate through hash ranges to find the matching partition for i, (start, end) in
  enumerate(hash_ranges):
    if start <= score_hash <= end:
      return i
  # Iterate through each participant and assign them to the appropriate partition
  for participant in dataset:
    score_hash = calculate_score_hash(participant.score )
    partition_index = map_to_partition(score_hash)
    partition_name = list(partitions.keys( ))[partition_index]
    partitions[partition_name].append(participant)
```

4. Update Partition Assignments: Periodically, or when significant changes occur in the dataset, partition assignments may need to be updated to maintain balance and efficiency. Updates may be triggered by factors such as the addition of new participants, changes in score structures, or shifts in the distribution of high scores. When updating partition assignments, the hash values are recalculated for high score of each participant and reassigned to partitions accordingly. Additionally, adjustments to weights may be made based on the updated distribution of scores across partitions.

### Handling New Records

Update Filters: This step involves updating the existing probabilistic filters based on data in the new records. These filters serve as a mechanism to quickly map data points to their corresponding partitions. For each new record, the hash values are recalculated for both high score and experience level and the filters updated accordingly.

Update Probabilistic Filters for High Score: For each new high score value, its hash is calculated and the corresponding bits in the score filter updated. This process ensures that the filter accurately reflects the distribution of scores across different partitions. By updating the filter, an efficient mechanism is maintained for mapping salaries to partitions during data access and query processing.

```
def update_score_filter(score _hash):
  # Update the existing probabilistic filter based on the new score hash
  # This involves setting the corresponding bit in the filter to 1
  # Implement the logic to update the filter based on the score hash
  pass # Placeholder for implementation
# Iterate through new records and update the score filter for record in new_records:
  score_hash = calculate_score_hash(record.score)
  update_score_filter(score_hash)
```

Update Probabilistic Filters for Experience Level: Similar to updating the high score filter, the hash values for new experience level data are calculated and the experience level filter is updated accordingly. This step ensures that the filter accurately represents the distribution of levels across partitions. By keeping the filter up to date, the process of mapping levels to partitions during data access and query execution is optimized.

```
def update_level_filter(level_hash):
  # Update the existing probabilistic filter based on the new level hash
  # This involves setting the corresponding bit in the filter t o 1
  # Implement the logic to update the filter based on the level hash
  pass # Placeholder for implementation
# Iterate through new records and update the level filter for record in new_records:
  level_hash = calculate_level_hash(record.level)
  update_level_filter(level_hash)
```

Update Partition Assignments: Once the filters are updated, the new records are reassigned to the appropriate partitions based on their updated hashes. This involves mapping each new record to the corresponding partition based on its highs score and experience level hash values. Additionally, it is aimed to maintain balance between partitions by considering both high score and experience level criteria during partition assignment.

```
# Reassign new records to partitions based on updated filters for record in new_records:
  score_hash = calculate_score_hash(record.score)
  level_hash = calculate_level_hash(record.level)
# Map the new record to the appropriate partition based on the updated filters
  score_partition_index = map_to_partition(score_hash)
  level_partition_inde x = map_to_partition(level_hash)
# Ensure balance between partitions by considering both high score and experience level
hashes
  final_partition_inde x = balance_partitions(score_partition_index, level_partition_index)
# Assign the record to the final partition
  partition_paticipant = list(partitions.keys( ))[final_partition_index]
  partitions[partition_participant].append(record)
```

Maintain Balance Between Partitions: In this step, it is ensured that the partitions remain balanced by considering both high score and experience level criteria. The balance_partitions function evaluates the distribution of new records across partitions and adjusts the assignment to maintain an even distribution. By considering both high score and experience level hashes, the aim is to prevent any single partition from becoming overloaded or underutilized, thereby optimizing query performance and data access efficiency.

### Accessing Stored Database Information

Query Processing: When a query is submitted to retrieve information from the database, the system initiates the query processing phase. The query typically includes conditions or filters based on specific criteria, such as experience level, high score, or both.

Analyze Query Criteria: The system analyzes the query criteria to identify the relevant partitions based on the specified conditions. For example, if the query seeks participants having an experience level higher than 30 and having a high score above 50,000, the system identifies the partitions that potentially contain relevant data based on the experience level and high score filters.

Prioritize Relevant Partitions: Using the probabilistic filters for both experience level and high score, the system prioritizes the partitions that are most likely to contain data matching the query criteria. This prioritization is based on the hash values generated from the query conditions and their corresponding positions in the filters.

Bitwise AND Operation: The system performs a bitwise AND operation on the filters corresponding to the identified partitions. This operation helps refine the selection by filtering out partitions that do not meet all the specified criteria. For example, if a partition does not contain participants having an experience level higher than 30 and having a high score above 50,000, its corresponding bits in the filters will be unset.

Final Result: After performing the bitwise AND operation, the system derives a final result indicating the partitions that match all the specified criteria. If there are no matching partitions, the system returns an empty result set, indicating that no participants meet the query conditions. Otherwise, the system proceeds to retrieve the data from the identified partitions for further processing or presentation to the user.

For implementing, the process_query function orchestrates the query processing pipeline by invoking helper functions to identify relevant partitions, prioritize them using probabilistic filters, perform bitwise AND operation, and derive the final result. Each helper function encapsulates specific logic related to its respective step in the process.

```
def process_query(query_criteria):
  relevant_partitions = prioritize_partitions(query_criteria)
  final_result = bitwise_and_operation(relevant_partitions)
  return final_result
def prioritize_partitions(query_criteria):
  # Identify relevant partitions based on query criteria
  relevant_partitions = identify_relevant_partitions(query_criteria)
  # Prioritize partitions using probabilistic filters
  prioritized_partitions = prioritize_partitions_using_filters(relevant_partitions)
  return prioritized_partitions
def bitwise_and_operation(relevant_partitions):
# Perform bitwise AND operation on filters corresponding to relevant partitions
  final_result = perform_bitwise_and(relevant_partitions)
  return final_result
def identify_relevant_partitions(query_criteria):
  # Logic to identify partitions based on query criteria
  relevant_partitions = ...
  return relevant_partitions
def prioritize_partitions_using_filters(relevant_partitions):
  # Logic to prioritize partitions using probabilistic filters
  prioritized_partitions = ...
  return prioritized_partitions
def perform_bitwise_and(relevant_partitions):
# Logic to perform bitwise AND operation on filters
  final_result = ...
  return final_result
# Example query criteria
query_criteria = {
  ‘experience_level’: ‘>30’ ,
  ‘high_score’: ‘>50000’
}
# Process query
result = process_query(query_criteria)
```

### AI-Driven Optimization:

Continuous Monitoring: The AI-driven optimization process begins with continuous monitoring of query performance and database usage patterns. The system tracks metrics such as query execution time, resource utilization, and data access patterns over time.

Data Collection: Data pertaining to query performance, database usage, and system resource utilization is collected and stored for analysis. This data serves as the basis for identifying patterns and trends that can inform optimization strategies.

Analysis and Learning: Using machine learning techniques, the system analyzes the collected data to identify patterns, correlations, and anomalies. It learns from historical query executions and database usage to understand how different factors affect performance and resource utilization.

Optimization Strategy Generation: Based on the insights gained from data analysis, the system generates optimization strategies aimed at improving query performance and resource efficiency. These strategies may include: (i) adjusting partitioning schemes, (ii) optimizing indexing, (iii) caching frequently accessed data, and (iv) dynamically allocating resources based on workload patterns.

Reinforcement Learning: The optimization process incorporates reinforcement learning techniques to iteratively refine and improve optimization strategies over time. The system evaluates the effectiveness of implemented strategies and adjusts them based on feedback from ongoing monitoring and analysis.

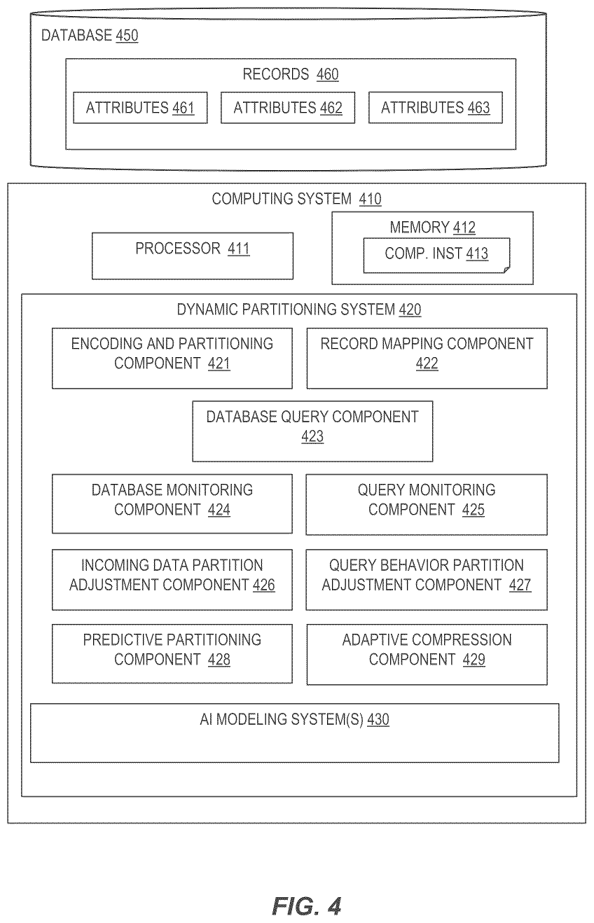

Referring to FIG. 4, a block diagram shows an example embodiment of the described system. The system includes a database 450 having records 460 with attributes 461-463 to which binary block partitioning for compression is applied by a dynamic partitioning system 420 provided on one or more computing systems 410. A computing system 410 include at least one processor 411, a hardware module, or a circuit for executing the functions of the described components which may be software units executing on the at least one processor. Multiple processors running parallel processing threads may be provided enabling parallel processing of some or all of the functions of the components. Memory 412 may be configured to provide computer instructions 413 to the at least one processor 411 to carry out the functionality of the components.

The dynamic partitioning system 420 includes an encoding and partitioning component 421 for dynamically providing partitions of the database by encoding attributes of the records into binary representations and assigning each attribute value to a partition based on its binary form to provide a probabilistic filter for each attribute. The dynamic partitioning system 420 includes a record mapping component 422 for assigning mappings to identify a partition for an attribute value. The encoding and partitioning component 421 dynamically adjusts the partitioning as described.

The dynamic partitioning system 420 includes a database query component 423 for analyzing query criteria to the database to identify partitions relevant to a query and prioritizing partitions for data retrieval for the query based on the probabilistic filters.

The dynamic partitioning system 420 includes a database monitoring component 424 for monitoring database usage and historical data patterns.

The dynamic partitioning system 420 includes a query monitoring component 425 for monitoring query performance and database usage.

The dynamic partitioning system 420 includes an incoming data partition adjustment component 426 for analyzing monitored historical data patterns and anomalies using machine learning for adjusting the partitions.

The dynamic partitioning system 420 includes a query behavior partition adjustment component 427 for analyzing monitored query performance data using machine learning and adjusting the partitions to optimize query performance based on the monitoring and analysis.

The dynamic partitioning system 420 includes a predictive partitioning component 428 for forecasting future data distribution and access patterns based on historical data and external factors and proactively adjusting the partitions.

The dynamic partitioning system 420 includes an adaptive compression component 429 for providing adaptive compression and encoding based on characteristics of each partition.

The dynamic partitioning system 420 may include for access AI modeling systems 430 for applying machine learning techniques for analysis and reinforcement learning based on historical data patterns.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

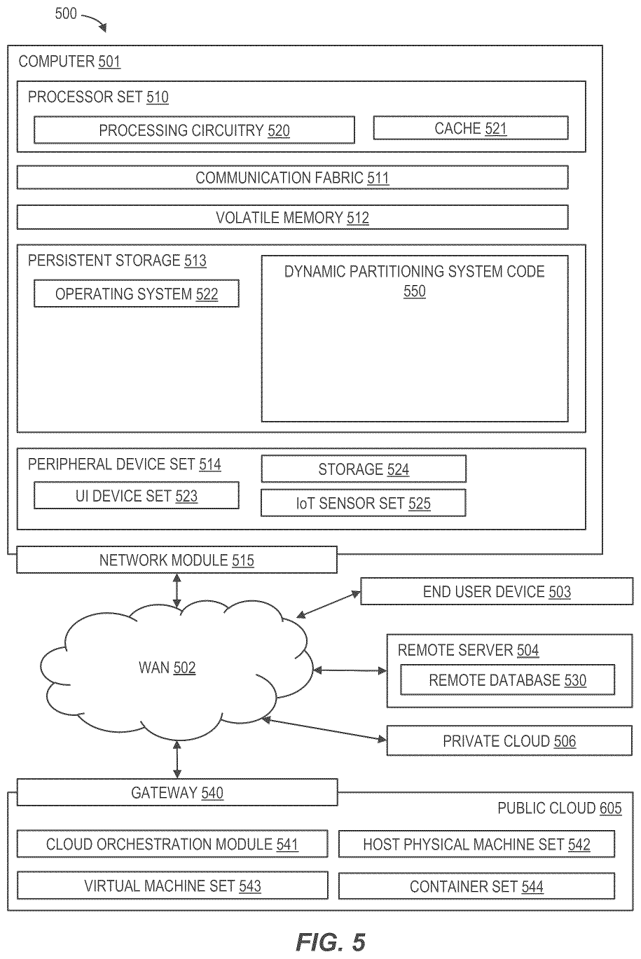

Referring to FIG. 5, computing environment 500 contains an example of an environment for the execution of at least some of the computer code involved in performing the inventive methods, such as dynamic partitioning system code 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer, and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

1. A computer-implemented method for binary block partitioning for compression of a database having a plurality of records with multiple attributes, the computer-implemented method comprising:
dynamically providing partitions of the database by encoding attributes of the records into binary representations and assigning each attribute value to a partition based on its binary form to provide a probabilistic filter for each attribute;
assigning mappings to identify a partition for an attribute value wherein the mappings are derived from the probabilistic filters; and
analyzing query criteria to the database by:
identifying a set of candidate partitions relevant to a query using the probabilistic filters; and
prioritizing the set of candidate partitions for data retrieval responsive to the query based on query behavior and historical access data, including applying a machine learning model trained on historical query execution data to select, among the candidate partitions, priority partitions most likely to contain data satisfying the query.

2. The computer-implemented method of claim 1, wherein dynamically providing partitions includes:
encoding attributes of the records into binary representations;
assigning each attribute value to a partition based on its binary form, wherein partitions are grouped by common patterns or sequences in the binary representations; and
creating a probabilistic filter for each attribute by updating binary blocks based on the encoded attribute values, wherein each block corresponds to a distinct range or category of attribute values.

3. The computer-implemented method of claim 1, further comprising:
monitoring query performance by collecting and analyzing query metrics to identify optimization opportunities; and
adjusting the partitions to optimize query performance.

4. The computer-implemented method of any of claim 1, further comprising:
predicting future data distribution and query workloads; and
proactively adjusting the partitions by reallocating attribute values based on the predictions and real-time analysis to optimize query performance.

5. The computer-implemented method of claim 1, further comprising:
dynamically adjusting the partitions to optimize storage efficiency by adapting compression and encoding for each partition based on characteristics of each partition.

6-7. (canceled)

8. The computer-implemented method of claim 1, further comprising:
partitioning data using bitwise operations and grouping records with specific bit positions to enable optimization where certain bits are set or unset.

9. The computer-implemented method of claim 1, further comprising
dynamically updating partition assignments for new or changed records and updating the probabilistic filters based on the new or changed records, wherein the new or changed records comprise records newly added to or modified within the database.

10. The computer-implemented method of claim 1, further comprising:
monitoring historical data patterns and anomalies in the database to refine partitioning based on binary characteristics; and
adjusting the partitions dynamically in response to data patterns and anomaly detection.

11. (canceled)

12. The computer-implemented method of claim 1, further comprising:
applying reinforcement learning to improve partitioning over time based on feedback from monitoring and analysis.

13. The computer-implemented method of claim 1, further comprising:
analyzing a distribution of attributes across the partitions and assigning weights to partitions based on the distribution;
iterating through the records to calculate hash values for the record attributes and assigning the hash values to a partition based on the probabilistic filter; and
updating partitions and weights based on changes in the database and recalculate hash values to reassign them to the updated partitions.

14. A computer system for binary block partitioning for compression of a database having a plurality of records with multiple attributes, the computer system comprising:
a memory containing one or more instructions; and
a processor communicatively coupled to the memory, the processor, in response to reading the one or more instructions, configured to perform operations comprising:
dynamically providing partitions of the database by encoding attributes of the records into binary representations and assigning each attribute value to a partition based on its binary form to provide a probabilistic filter for each attribute;
assigning mappings to identify a partition for an attribute value wherein the mappings are derived from the probabilistic filters; and
analyzing query criteria to the database by:
identifying a set of candidate partitions relevant to a query using the probabilistic filters; and
prioritizing the set of candidate partitions for data retrieval responsive to the query based on query behavior and historical access data, including applying a machine learning model trained on historical query execution data to select, among the candidate partitions, priority partitions most likely to contain data satisfying the query.

15. The computer system of claim 14, wherein dynamically providing partitions includes:
encoding attributes of the records into binary representations;
assigning each attribute value to a partition based on its binary form, wherein partitions are grouped by common patterns or sequences in the binary representations; and
creating a probabilistic filter for each attribute by updating binary blocks based on the encoded attribute values, wherein each block corresponds to a distinct range or category of attribute values.

16. The computer system of claim 14, wherein the operations further comprise:
forecasting future data distribution and access patterns based on historical data and external factors; and
proactively adjusting the partitions.

17. The computer system of any of claim 14, wherein the operations further comprise:
providing adaptive compression and encoding based on characteristics of each partition.

18. The computer system of any of claim 14, wherein the operations further comprise:
dynamically updating partition assignments for new or changed records and updating the probabilistic filters based on the new or changed records, wherein the new or changed records comprise records newly added to or modified within the database.

19. The computer system of any of claim 14, wherein the operations further comprise:
monitoring historical data patterns and anomalies in the database to refine partitioning based on binary characteristics; and
adjusting the partitions dynamically in response to data patterns and anomaly detection.

20. A computer program product comprising:
one or more computer-readable storage media; and
a set of instructions stored on the one or more computer-readable storage media, the set of instructions, when executed by a processor, causes the processor to partition binary blocks for compression of a database having a plurality of records with multiple attributes by:
dynamically providing partitions of the database by encoding attributes of the records into binary representations and assigning each attribute value to a partition based on its binary form to provide a probabilistic filter for each attribute;
assigning mappings to identify a partition for an attribute value wherein the mappings are derived from the probabilistic filters; and
analyzing query criteria to the database by:
identifying a set of candidate partitions relevant to a query using the probabilistic filters; and
prioritizing the set of candidate partitions for data retrieval responsive to the query based on query behavior and historical access data, including applying a machine learning model trained on historical query execution data to select, among the candidate partitions, priority partitions most likely to contain data satisfying the query.

21. The computer program product of claim 20, wherein the prioritizing includes dynamically determining, at query time, the priority partitions to be retrieved based on machine learning analysis of the query behavior.

22. The computer system of claim 14, wherein the prioritizing includes dynamically determining, at query time, the priority partitions to be retrieved based on machine learning analysis of the query behavior.

23. The method of claim 1, wherein the prioritizing includes dynamically determining, at query time, the priority partitions to be retrieved based on machine learning analysis of the query behavior.
